(19) United States
(12) Patent Application Publication
(10) Pub. No.: US 2003/0232104 A1
(43) Pub. Date: Dec. 18, 2003

(54) Concrete mold and product made therefrom

(76) Inventor: Burma Brown, Pasadena, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/170,846

(22) Filed: Jun. 12, 2002

(51) Int. Cl. B29C 41/04

(52) U.S. Cl. 425/418; 425/435

(57) ABSTRACT

A mold and a product molded in the mold comprises a square block having a bottom face, a top face and a side wall between the top and bottom faces. The top face provides a circular depression with a central protrusion extending upwardly from the circular depression and terminating with a top surface above the top face of the square block. The circular depression provides an annular radius and an outwardly divergent side surface. The molded product is formed within the circular depression between the central protrusion and the side surface and is preferably made of concrete or similar material.

### BACKGROUND OF THE INVENTION

### INCORPORATION BY REFERENCE

Applicant(s) hereby incorporate herein by reference, any and all U.S. patents, U.S. patent applications, and other documents and printed matter cited or referred to in this application.

### Field of the Invention

This invention relates generally to molds and more particularly to a mold for forming a concrete product for protecting a sprinkler head.

### Description of Related Art

The following art defines the present state of this field:

Horning, U.S. Pat. No. 1,162,924 describes a combination of a mold for forming tubular pipe sections having an outer rotatory shell and a nonrotatory core fitted therein, a separable reaming collar in telescopic union with, the upper end of the core, means for locking, said collar and core together, and a trowel member carried by the collar adapted to finish the upper end of the molded pipe-section.

Uetzmann, U.S. Pat. No. 3,252,683 describes a combination of a ring mold and a cover-plate, said ring mold having an outer annular wall and an inner annular wall connected by an arcuate bottom wall, said cover-plate having a flat base with an outer annular wall and an inner annular wall, the inner surfaces of the walls of said lower plates engaging the edges of said ring mold annular walls to enclose said mold, and locking means integral with the surfaces of said inner annular walls of said mold and cover-plate for interengaging the mold with said cover-plates, said inner annular walls of the mold and cover-plate being higher than the outer annular walls of said mold and cover-plate, whereby on turning the ring mold and cover-plate over, the ring mold becomes the cover and the cover becomes a plate.

Becker, U.S. Pat. No. 4,170,443 describes an apparatus for forming a concrete shield around a sprinkler head that is a frusto-conical shaped form having a removable concentric flexible sleeve therein. A rotatable trowel is positioned inside the form to smooth the upper concrete surface. An inverted cup adapted to fit over the head of the sprinkler during the concrete forming process prevents wet concrete from contacting the top of the sprinkler head.

Reardon, U.S. Pat. No. 4,395,015 describes a mold for cakes having an annular side wall and a plurality of concentric inner annular dividing walls with heights which are approximately half the height of the side wall, which are tapered upwardly, and which are coated with polytetrafluoroethylene (Teflon).

Takahashi et al., U.S. Pat. No. 4,411,175 describes a ring-shaped mold of the split mold type constructed by assembling into an annular shape a plurality of sectorial separate blocks formed by cutting a ring-shaped workpiece having a mold surface on the annular circumference thereof, and the method and apparatus for making the same are disclosed. Sector lines interfacing adjoining the separate blocks on the mold surface intersect the circumference of the ring-shaped mold at angles not perpendicular to said circumference.

Tsao et al., U.S. Pat. No. 5,678,363 describes a grass guard for forming a vegetationless border around a perimeter of an object, such as a lawn sprinkler head. One particular embodiment consists of a two layer construction. The top layer is a plastic sheet simulating grass. The bottom layer is made of a heavy grit bonded into a uniform body with a polymer. The layers form a relatively thin, weather resistant, plastically compliant disk with a center hole for stretch, self-adjusting fit over a pre-installed sprinkler head. The device is also easily cut through with a knife to fit various head locations. The bottom layer has an outside vertical edge with a top rounded corner enclosing the top layer to prevent edge delamination or fraying. An adhesive is provided to bond the grass guard to the neck of the sprinkler head to eliminate gap formation around the head. A hammering board can be used to facilitate the installation. Optionally, pre-watering the vicinity of the sprinkler head until the ground is softened from moisture further simplifies the installation and enhances the quality. In general, the device can be used to guard against the growth of vegetation next to any physical objects with the proper tailoring of geometry and choice of associated manufacturing process.

The prior art teaches methods for making molds and the molds for pouring concrete objects, but does not teach the specialty mold of the present invention. The present invention fulfills these needs and provides further related advantages as described in the following summary.

### SUMMARY OF THE INVENTION

The present invention teaches certain benefits in construction and use which give rise to the objectives described below.

A mold and a product molded in the mold comprises a square block having a bottom face, a top face and a side wall between the top and bottom faces. The top face provides a circular depression with a central protrusion extending upwardly from the circular depression and terminating with a top surface above the top face of the square block. The circular depression provides an annular radius and an outwardly divergent side surface. The molded product is formed within the circular depression between the central protrusion and the side surface and is preferably made of concrete or similar material.

A primary objective of the present invention is to provide an apparatus and method of use of such apparatus that provides advantages not taught by the prior art.

Another objective is to provide such an invention capable of easily extracting a molded part.

A further objective is to provide such an invention capable of being centrifuged for compacting a mold material.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a top plan view of the preferred embodiment of a mold of the invention;

FIG. 2 is a side elevational view thereof; and

FIG. 3 is a perspective view of a product made in the mold of FIGS. 1 and 2.

### DETAILED DESCRIPTION OF THE INVENTION

The above described drawing figures illustrate the invention in at least one of its preferred embodiments, which is further defined in detail in the following description.

The present invention is a mold apparatus 5 comprises a square block having a bottom face 10, a top face 20 and a side wall 30 between the bottom and top faces, 10, 20. The top face 20 provides a circular depression 40 therein with a central protrusion 50 extending upward from the circular depression 40 and terminating with a top surface 52 which is positioned above the top face 20 of the square block so as to prevent mold material from closing from one side of the molded product to another side. Preferably, the circular depression 40 provides an annular radius 42 and an outwardly divergent side surface 44. Preferably, the central protrusion 50 has a upwardly convergent side surface 54. The surfaces 44 and 54 enable a molded part to be easily extracted from the mold apparatus 5.

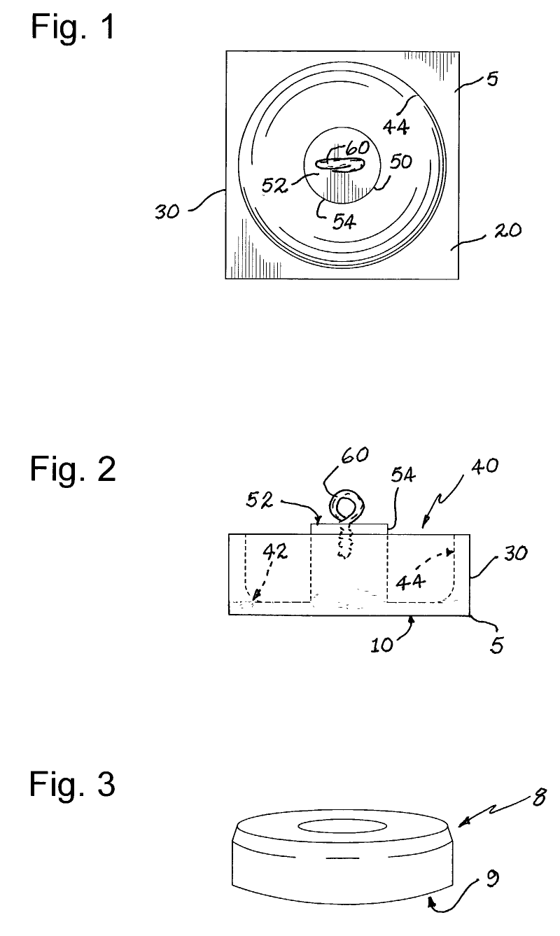

The present invention may also be considered, in a further embodiment, the mold apparatus 5, described above, and shown in FIGS. 1 and 2, and a product 8, shown in FIG. 3, molded therein, wherein, the molded product 8 is formed within the circular depression 40 between the central protrusion 50 and the side surface 44 so that the molded product presents an outward surface 9 contiguous with the top face 20 of the square block 5.

Preferably, an eye 60 is engaged with the top surface 52 of the central protrusion 50 for engaging a centrifuge (not shown) so that the mold apparatus 5 may be swung in a circle to enable centripetal forces to compact the molding material (not shown) and to cause heavier portions of the molding material to move to the bottom of the mold. This has the effect of making a part that has an improved, wear resistant outer surface and an improved general density.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A mold apparatus comprising: a square block having a bottom face, a top face and a side wall between the top and bottom faces; the top face providing a circular depression therein with a central protrusion extending upward from the circular depression and terminating with a top surface of the central protrusion above the top face of the square block.

2. The apparatus of claim 1 wherein the circular depression provides an annular radius and an outwardly divergent side surface.

3. The apparatus of claim 1 further comprising an eye engaged with the top surface of the central protrusion.

4. A mold apparatus and a product molded therein comprising in combination: a square block having a bottom face, a top face and a side wall between the top and bottom faces; the top face providing a circular depression therein with a central protrusion extending upward from the circular depression and terminating with a top surface of the central protrusion above the top face of the square block, the circular depression providing an annular radius and an outwardly divergent side surface; and the molded product formed within the circular depression between the central protrusion and the side surface, the molded product presenting an outward surface contiguous with the top face of the square block.

5. The apparatus of claim 4 further comprising an eye engaged with the top surface of the central protrusion.
